(19) United States
(12) Patent Application Publication
(10) Pub. No.: US 2006/0124412 A1
(43) Pub. Date: Jun. 15, 2006

(54) Compressed-gas cylinder weight measuring device

(76) Inventor: Li-Huan Chen, Kaohsiung County (TW)

Correspondence Address: Li-Huan CHEN, P.O. Box No. 6-57, Junghe, Taipei, 235, TW

(21) Appl. No.: 11/007,294

(22) Filed: Dec. 9, 2004

(51) Int. Cl. F16D 65/04

(52) U.S. Cl. 188/245

(57) ABSTRACT

The present invention relates to a compressed-gas cylinder weight measuring device having a main body, beams, a vernier, a graduated scale, and sliding weight, wherein beams connected to the main body, the sliding weight with inner thread formed on the beam, the vernier formed on an end of the sliding weight, the graduated scale formed on the main body, thereby enabling the compressed-gas cylinder weight to be easily read from the graduated scale and also from a vernier when rotating the sliding weight.

### BACKGROUND OF THE INVENTION

(a) Field of the Invention

The present invention relates to a compressed-gas cylinder weight measuring device, which is the lever theory application, by first moving a vernier-incorporated sliding weight, with a graduated scale in the front, along a beam to an assumed weight position, then hanging a compressed-gas cylinder and rotating the sliding weight again for meticulous adjustment to reach a balance status, thereby enabling the compressed-gas cylinder weight being read from the graduated scale and also from a vernier.

(b) Description of the Prior Art

To weigh a compressed-gas cylinder, a worker must rotate a sliding weight exhaustedly along the beam of a conventional weighing device to reach a balance statue, which is inconvenient at all, besides that the compressed-gas cylinder is too heavy that makes the sliding weight movement difficult.

### SUMMARY OF THE INVENTION

The present invention relates to a compressed-gas cylinder weight measuring device by moving a vernier-incorporated sliding weight, with a graduated scale in the front, along a beam to an assumed weight position and then rotating the sliding weight, when the compressed-gas cylinder hanged, for meticulous adjustment to reach a balance status, thereby enabling the compressed-gas cylinder weight to be read from the graduated scale and also from the vernier.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows an exploded elevational view of the present invention.

FIG. 2 shows a perspective view of the present invention with an enlarged section.

FIG. 3 shows a perspective view of a vernier incorporated on the present invention.

FIG. 4 shows a perspective view of the present invention when in practical application.

FIG. 5 shows another perspective view of the present invention when in practical application.

### DETAILED DESCRIPTION OF THE PREFERRED EMBODIMENTS

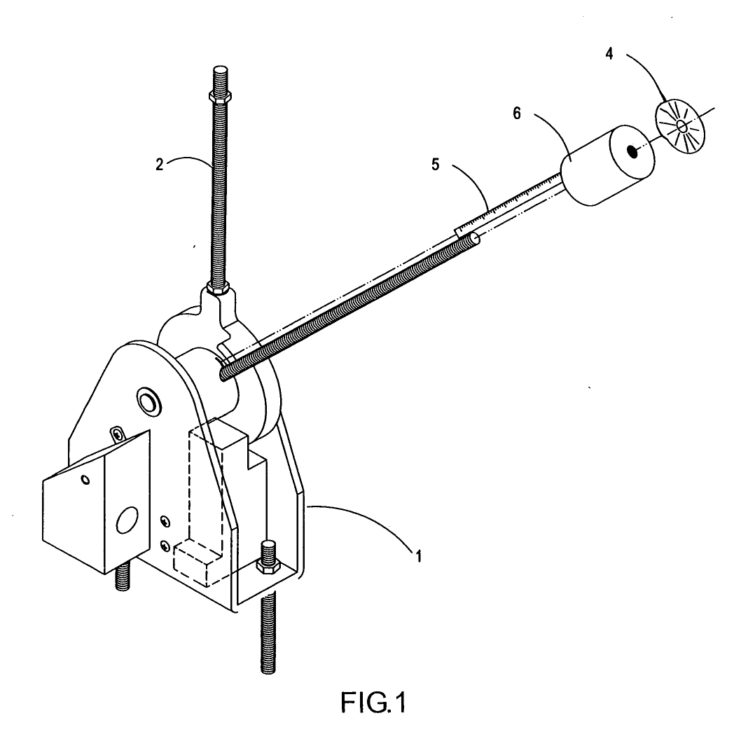

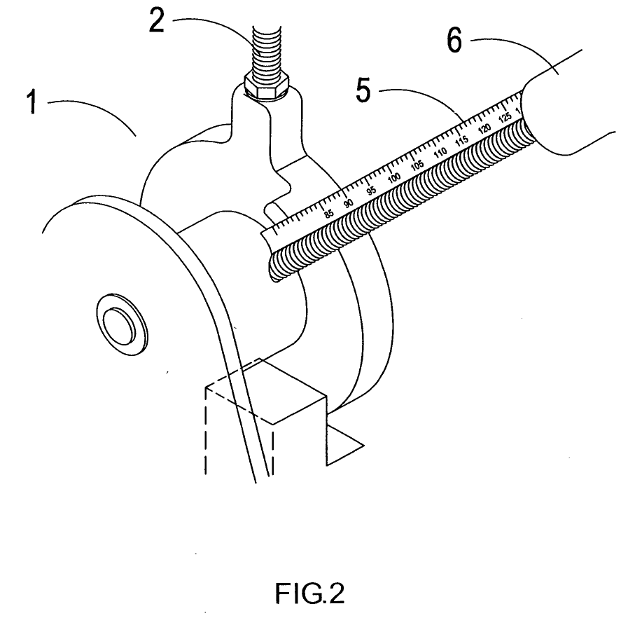

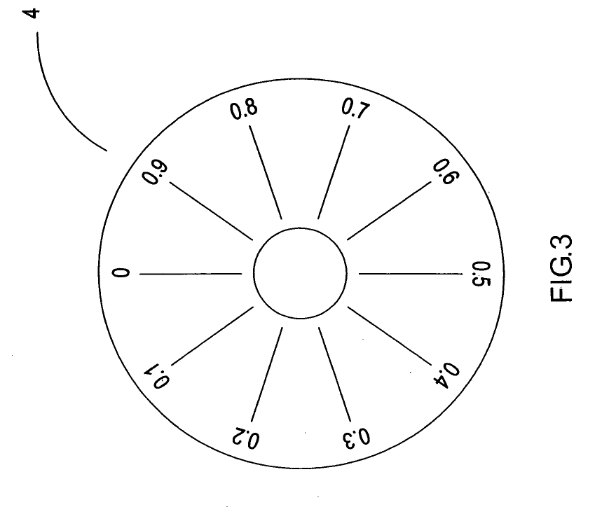

Referring to FIGS. 1 to 3. The present invention relates to a compressed-gas cylinder weight measuring device including a main body 1, beams 2 and 3, a vernier 4, a graduated scale 5, and a sliding weight 6, wherein beams 2 and 3 connected to the main body 1, the sliding weight 6, with inner threads, formed on the beam 3, the vernier 4 formed on an end of the sliding weight 6, the graduated scale 5 formed on the main body 1.

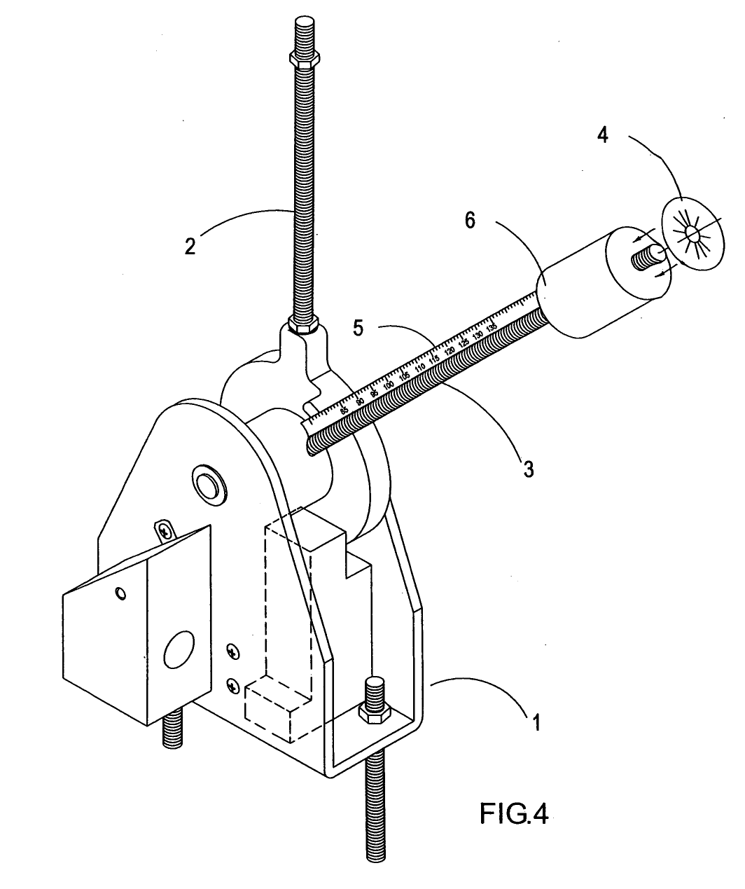

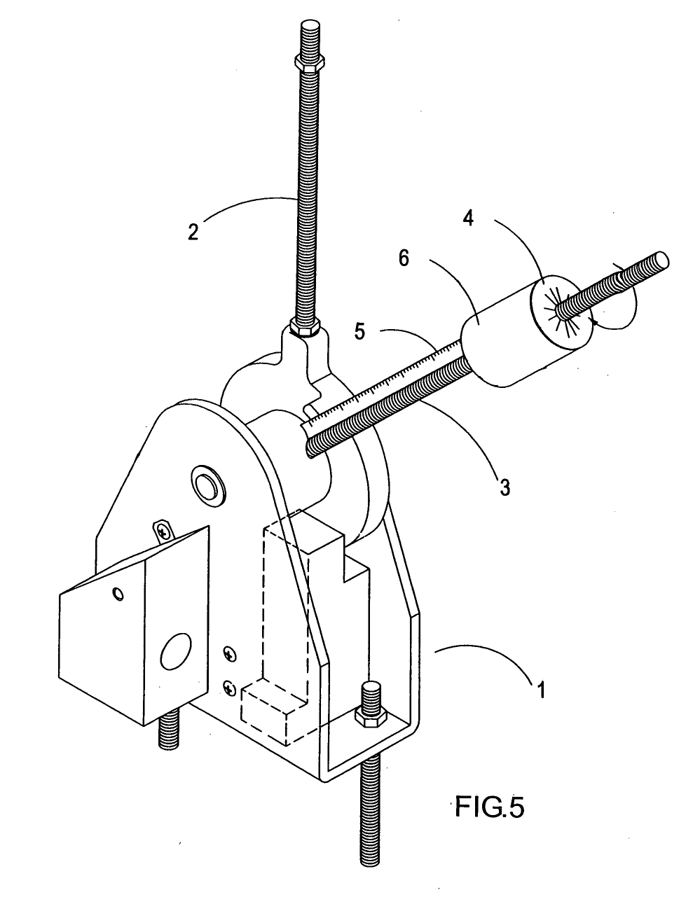

Referring to FIGS. 4 and 5. To use the device, first moving a vernier 4 incorporated sliding weight 6, with graduated scale 5 in the front, along a beam 3 to a position of an assumed standard compressed-gas cylinder weight, then hanging the compressed-gas cylinder and rotating the sliding weight 6 again for meticulous adjustment to reach a balance status, thereby enabling the compressed-gas cylinder weight to be read from the graduated scale 5 and also from a vernier 4.

Disadvantage of a conventional product:
1. Sliding weight can only be adjusted slowly;
2. It's a time-consuming process for adjusting sliding weight;
3. The compressed-gas cylinder is heavy, making adjustment uneasy;
4. Adjustment can't be done swiftly;
5. It's not an advancement product.

Advantages of the present invention:
1. It's easy and simple to make an adjustment;
2. Adjustment can be done swiftly;
3. It's a product enhancing practicality and convenience;
4. It's a product helpful to business operations.

It is of course to be understood that the embodiment described herein is merely illustrative of the principles of the invention and that a Wide variety of modifications thereto may be effected by persons skilled in the art without departing from the spirit and scope of the invention as set forth in the following claims.

What is claimed is:

1. A compressed-gas cylinder weight measuring device comprising a main body, beams, a vernier, a graduated scale, and sliding weight, wherein beams connected to the main body, the sliding weight with inner thread formed on the beam, the vernier formed on an end of the sliding weight, the graduated scale formed on the main body, thereby enabling the compressed-gas cylinder weight to be easily read from the graduated scale and also from a vernier when rotating the sliding weight.
